(19) United States
(12) Patent Application Publication
(10) Pub. No.: US 2015/0347324 A1
(43) Pub. Date: Dec. 3, 2015

(54) System and Method for Shared Memory for FPGA Based Applications

(71) Applicant: S2C INC., San Jose, CA (US)

(72) Inventors: Tomoyuki Tsuji, Kanagawa (JP); Theodore Lambert Ndzana Ndoua, Tokyo-to Machida-shi (JP)

(21) Appl. No.: 14/724,864

(22) Filed: May 29, 2015

Related U.S. Application Data
(60) Provisional application No. 62/004,923, filed on May 30, 2014.

(51) Int. Cl. G06F 12/14; G06F 13/42; G06F 13/16

(52) U.S. Cl. CPC G06F 12/1475; G06F 13/1663; G06F 13/4234; G06F 2212/1052

(57) ABSTRACT

A system for shared memory for field programmable gate array based application which includes a host computer, at least one field program gate array and a physical interface is disclosed. The host computer includes a host computer processor, a host computer memory, a shared memory, a host computer interface and a host computer design bus. The host computer design bus is electrically connected to the host computer processor, the host computer memory, the shared memory, and the host computer interface. The field program gate array includes a field program gate array processor, a field program gate array memory, a field program gate array design bus and a field program gate array interface. The field program gate array design bus is electrically connected to the field program gate array processor, the field program gate array interface and the field program gate array memory.

### BACKGROUND OF THE INVENTION

1. Field of the Invention

The present invention relates to system for shared memory for FPGA (Field Programmable Gate Array, FPGA) based application; more particularly, the present invention relates to system for shared memory for FPGA based application, for allowing a plurality of processes from both a computer and a field programmable gate array to access simultaneously to a memory.

2. Description of the Related Art

A field-programmable gate array (FPGA) is an integrated circuit designed to be configured by a program designer for developing and checking the circuit design. To increase the development efficiency, many FPGA companies have researched many different functions for FPGA. The object of this invention is to provide a new system which allows a memory to be simultaneously accessed by multiple design processes from both a computer and FPGA, allowing the user to use computer memory to emulate a design memory in their FPGA design, and the user can modify the design contents quickly and easily for testing different FPGA design conditions, the user can use other simulation or debug tools to run parallel processes while the FPGA design is still running, and to resolve the potential FPGA design partition bottleneck where processes in multiple FPGAs all need to access a same memory.

### SUMMARY OF THE INVENTION

It is an object of the present invention to provide a system for shared memory for field programmable gate array (FPGA) based application, for allowing a plurality of processes from both a computer and a field programmable gate array to access simultaneously to a memory.

To achieve the abovementioned object, the system for shared memory for field programmable gate array based application includes a host computer, at least one field program gate array and a physical interface. The host computer includes a host computer processor, a host computer memory, a shared memory, a host computer interface and a host computer design bus. The host computer design bus is electrically connected to the host computer processor, the host computer memory, the shared memory, and the host computer interface. The at least one field program gate array includes a field program gate array processor, a field program gate array memory, a field program gate array design bus and a field program gate array interface. The field program gate array design bus is electrically connected to the field program gate array processor, the field program gate array interface and the field program gate array memory. The field program gate array interface includes a shared memory controller, a descriptor block, a master interface, and a host computer connecting physical interface. The master interface is used for connecting to the field program gate array design bus. The host computer connecting physical interface is used for connecting to the host computer interface, and the host computer connecting physical interface is electrically connected to the shared memory controller, the descriptor block and the master interface. The physical interface is connected to the host computer interface and the host computer connecting physical interface.

According to one embodiment of the invention, the field program gate array interface further comprises a slave interface, electrically connected to the host computer connecting physical interface.

According to one embodiment of the invention, the physical interface is a Peripheral Component Interconnect Express (PCIe) interface, or a Serial Advanced Technology Attachment (SATA) interface.

According to one embodiment of the invention, the host computer interface includes a computer driver for allowing the physical interface to map a design bus function, wherein the design bus function is reading or writing.

According to one embodiment of the invention, the field program gate array interface converts a protocol for the physical interface to a protocol for the field program gate array design bus.

According to one embodiment of the invention, the host computer connecting physical interface is implemented in the at least one field program gate array, or implemented on the outside of the at least one field program gate array.

According to one embodiment of the invention, the shared memory is physically scattered in a plurality of small segments in the host computer memory, and the descriptor block is used for storing an information to map the shared memory to the host computer memory.

According to one embodiment of the invention, the information comprises a size, a status, a host physical memory starting address, and a pointer.

It is another object of the present invention to provide a method for shared memory for field programmable gate array based application, for allowing a plurality of processes from both a computer and a field programmable gate array to access simultaneously to a memory.

To achieve the abovementioned object, the method for shared memory for field programmable gate array based application is applied to a system comprising a host computer, a field program gate array and a physical interface, wherein the host computer comprises a shared memory and a host computer memory, the field program gate array includes a descriptor block, the physical interface is connected to the host computer and the field program gate array. The method for shared memory for field programmable gate array based application includes the steps of: opening an access of the shared memory; receiving a request for accessing the shared memory; based on the requested shared memory size, locking the available host computer memory; writing an allocation information of the host computer memory to the descriptor block of the field program gate array; after the descriptor block is written, a plurality of processes or applications from the host computer and the field program gate array simultaneously access the shared memory via searching the allocation information of the host computer memory in the descriptor block; receiving a finishing access information; and closing the shared memory and free the locking host computer memory.

### BRIEF DESCRIPTION OF THE DRAWINGS

FIG. 1 illustrates a system structure drawing of a system for shared memory for field programmable gate array based application of one embodiment of the invention.

FIG. 2 illustrates a flowchart of a method for shared memory for field programmable gate array based application of one embodiment of the invention.

FIG. 3 illustrates a flowchart of the field programmable gate array and the host computer working process.

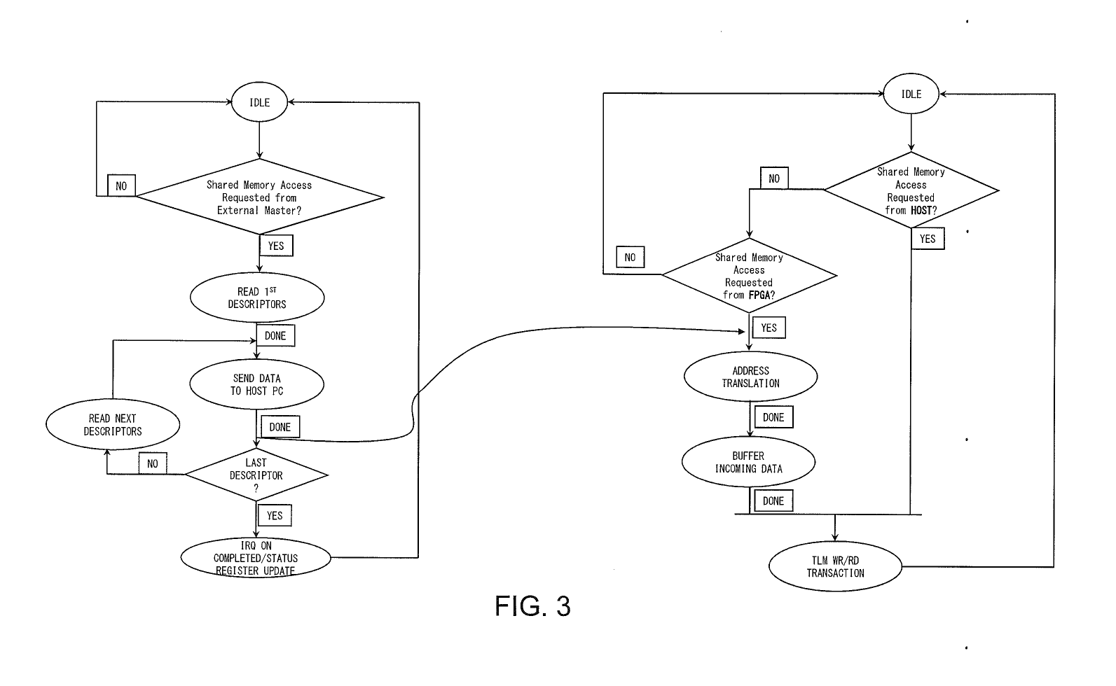

FIG. 4 illustrates an using schematic of the shared memory.

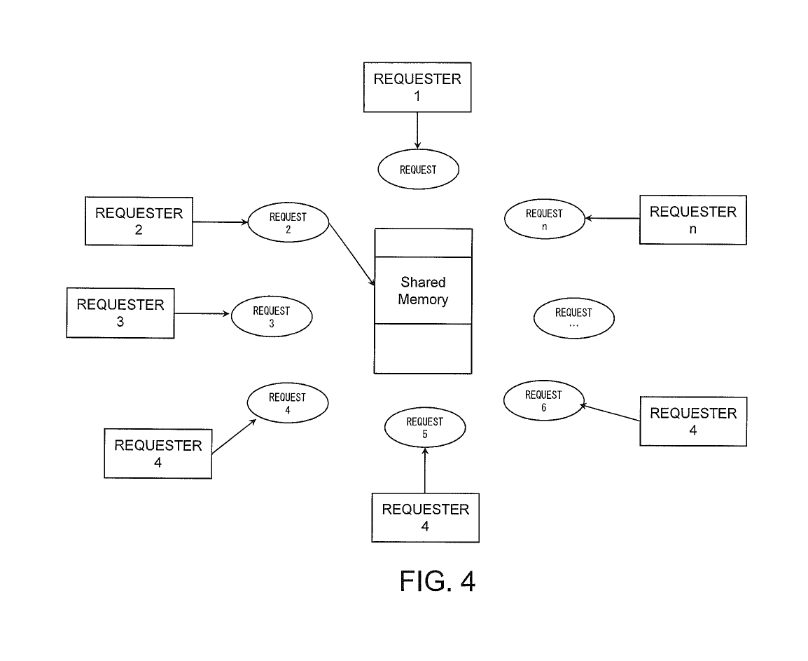

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

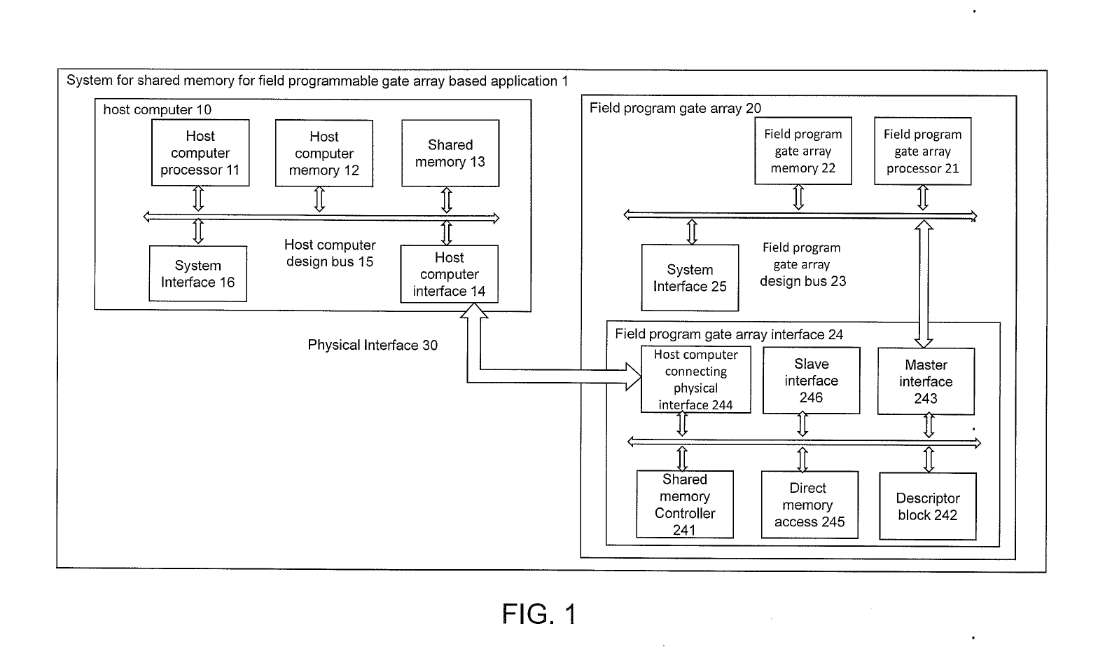

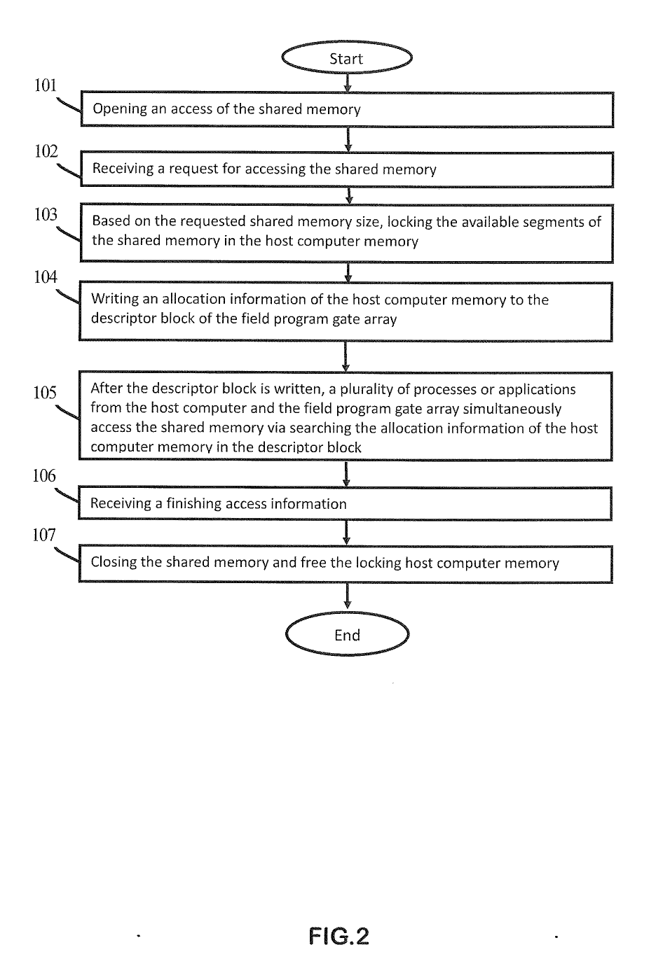

Please refer to FIG. 1 to FIG. 2, which illustrate the system and method for shared memory for field programmable gate array based application according to one embodiment of the present invention. FIG. 1 illustrates a system structure drawing of a system for shared memory for field programmable gate array based application of one embodiment of the invention. FIG. 2 illustrates a flowchart of a method for shared memory for field programmable gate array based application of one embodiment of the invention.

As shown in FIG. 1, in one embodiment of the present invention, the system for shared memory for field programmable gate array based application 1 is used for allowing a plurality of design processes from both a computer and a field programmable gate array to access simultaneously to a memory. The system for shared memory for field programmable gate array based application 1 includes a host computer 10, a field program gate array 20, and a physical interface 30. However, the amount of the field program gate array 20 is not limit to one, the amount can be changed according to the design requirement.

In one embodiment of the present invention, the host computer 10 is a desktop computer or a notebook for allowing the user to use, the host computer 10 includes a host computer processor 11, a host computer memory 12, a shared memory 13, a host computer interface 14, a host computer design bus 15 and a system interface 16. The host computer processor 11 is a center processor unit, which is used for controlling the electronic units of the host computer 10 to work. The host computer memory 12 is used for storing the application, the processing and the data for the host computer 10. The shared memory 13 is used for being accessed by the application or the processing of the host computer 10 or the field program gate array 20, and the shared memory 13 is physically scattered in a plurality of small segments in the host computer memory 12. The host computer interface 14 is used for connecting to the physical interface 30 and electrically connecting to the field program gate array 20, the host computer interface 14 includes a computer driver for allowing the physical interface 30 and the application programing interface (API) routines to map a design bus function, wherein the design bus function is reading or writing, such that the field program gate array 20 can execute writing or reading via the physical interface 30 and the host computer interface 14. The host computer design bus 15 is used for allowing the electronic signal of each electronic unit in the host computer 10 to be sent to each other. The system interface 16 is used for communicating to other external or internal electronic units of the host computer 10, such as a Compact Disc Read-Only Memory (CD-ROM) driver or a Universal Serial Bus (USB) slot.

In one embodiment of the present invention, the field program gate array 20 is an integrated circuit, which converts a protocol for the physical interface 30 to a protocol for the field program gate array design bus 23, such that the information can be delivered smooth between the host computer 10, the field program gate array 20 and the physical face 30. The field program gate array 20 includes a field program gate array processor 21, a field program gate array memory 22, a field program gate array design bus 23, a field program gate array interface 24 and a system interface 25. The field program gate array processor 21 is a center processor unit, which is used for controlling the electronic units of the field program gate array 20 to work. The field program gate array memory 22 is used for storing the application, the processing and the data for the field program gate array 20. The field program gate array design bus 23 is used for allowing the electronic signal of each electronic unit in the field program gate array 20 to be sent to each other, the field program gate array design bus 23 is electrically connected to the field program gate array processor 21, the field program gate array memory 22, the field program gate array interface 24 and the system interface 25. The field program gate array interface 24 is used for electrically connected to the host computer interface 14 via the physical interface 30. The field program gate array interface 24 includes a shared memory controller 241, a descriptor block 242, a master interface 243, a host computer connecting physical interface 244, a direct memory access 245 and a slave interface 246. The shared memory controller 241 is used for deliver the information and order to the shared memory 13 to map, access and control the shared memory 13. The descriptor block 242 is used for storing an information to map the shared memory 13 to the host computer memory 12, wherein the information comprises a size, a status, a host physical memory starting address, and a pointer; but the type of the information is not limited to that design. The master interface 243 is used for connecting to the field program gate array design bus 23 to electrically connect to other electronic units of the field program gate array 20. The host computer connecting physical interface 244 is used for connecting to the host computer interface 14 via the physical interface 30, and the host computer connecting physical interface 244 is electrically connected to the shared memory controller 241, the descriptor block 242, the master interface 243, the direct memory access 245 and the slave interface 246. The host computer connecting physical interface 244 is implemented in the field program gate array 20, or implemented on the outside of the field program gate array 20. The direct memory access 245 is used for allowing certain electronic units to access the host computer memory 12 or the shared memory 13 directly without using the host computer processor 11, to increase the working efficiency. The slave interface 246 is used for connecting to the other field program gate array design bus to electrically connect to other electronic units of the other field program gate array, if there are multiple field program gate arrays in the system for shared memory for field programmable gate array based application 1.

In one embodiment of the present invention, the physical interface 30 is a Peripheral Component Interconnect Express (PCIe) interface, or a Serial Advanced Technology Attachment (SATA) interface, for connecting to the host computer interface 14 and the host computer connecting physical interface 244, such that the host computer interface 14 and the host computer connecting physical interface 244 can communicate to each other; however, the type of the physical interface 30 is not limited to that design, it can be other high speed computer I/O unit.

As shown in FIG. 1 and FIG. 2, in one embodiment of the present invention, the method for shared memory for field programmable gate array based application is applied to the abovementioned system for shared memory for field programmable gate array based application 1. The method for shared memory for field programmable gate array based application is used for allowing a plurality of design processes from the host computer 10 and the field programmable gate array 20 to access simultaneously to the shared memory 13. To achieve the object, first, executing Step 101: Opening an access of the shared memory.

The user operates the host computer 10 to give an order to initialize the shared memory 13, then the host computer processor 11 opens the access of the shared memory 13.

Then, executing Step 102: Receiving a request for accessing the shared memory.

After the access of the shared memory 13 is opened, the user can use the application or the processing in the host computer memory 12 of the host computer 10 to send a request for accessing the shared memory 13 to the host computer processor 11; or the user can use the application or the processing in the field program gate array memory 22 of the field program gate array 20 to send a request for accessing the shared memory 13 to the host computer processor 11 via the field program gate array interface 24 and the physical interface 30. After the host computer processor 11 receives the request for accessing the shared memory 13, the host computer processor 11 will execute the following step.

Then, executing Step 103: Based on the requested shared memory size, locking the available segments of the shared memory in the host computer memory.

After the host computer processor 11 receives the request for accessing the shared memory 13, the host computer processor 11 will check the size of the shared memory 13, and lock the available segment of the shared memory 13 in the host computer memory 12 based on the requested shared memory size.

Then executing Step 104: Writing an allocation information of the host computer memory to the descriptor block of the field program gate array.

After the available segment of the shared memory 13 in the host computer memory 12 is locked, the host computer processor 11 sends an allocation information of the host computer memory 12 to the field program gate array processor 21 of the field program gate array 20 via the connecting of the physical interface 30. Then the field program gate array processor 21 writes the allocation information of the host computer memory 12 to the descriptor block 242 of the field program gate array interface 24 of the field program gate array 20.

Then executing Step 105: After the descriptor block is written, a plurality of processes or applications from the host computer and the field program gate array simultaneously access the shared memory via searching the allocation information of the host computer memory in the descriptor block.

After the allocation information of the host computer memory 12 is written into the descriptor block 242, via searching the allocation information of the host computer memory 12 in the descriptor block 242, the host computer 10 can access to write or read the shared memory 13, and the field program gate array 20 can map to the address of the segments for the shared memory 13 based on the allocation information, to access to write or read the shared memory 13 via the connecting between the host computer interface 14, the physical interface 30 and the host computer connecting physical interface 244.

Then executing Step 106: Receiving a finishing access information.

If the plurality of processes or applications do not need to use the shared memory 13 anymore, the plurality of processes or applications from the host computer 10 and the field program gate array 20 will send a finishing access information to the host computer processor 11. After the host computer processor 11 receives the finishing access information, the host computer processor 11 will execute the last step.

Finally, executing Step 107: Closing the shared memory and free the locking host computer memory.

After the host computer processor 11 receives the finishing access information, the host computer processor 11 will close the access of the shared memory 13 and free the locking host computer memory 12.

Via the design of the system and method for shared memory for field programmable gate array based application, the user can use the shared memory to emulate a design memory for the field program gate array design. The user can modify the contents in the shared memory to quickly and easily test the different field programmable gate array design conditions. The user can use other simulation or debug tools to run parallel processes while one field programmable gate array design is still running. This invention resolves the potential field programmable gate array design partition bottleneck where processes in multiple field programmable gate arrays all need to access a same memory. Via using this invention, all field programmable gate arrays can now access the same memory through a common physical interface.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope of the invention.

What is claimed is:

1. A system for shared memory for field programmable gate array based application, comprising:
a host computer, comprising:
a host computer processor;
a host computer memory;
a shared memory;
a host computer interface; and
a host computer design bus, electrically connected to the host computer processor, the host computer memory, the shared memory, and the host computer interface;
at least one field program gate array, comprising:
a field program gate array processor;
a field program gate array memory;
a field program gate array design bus, electrically connected to the field program gate array processor, and the field program gate array memory; and
a field program gate array interface, and comprising:
a shared memory controller;
a descriptor block;
a master interface, used for connecting to the field program gate array design bus; and
a host computer connecting physical interface, used for connecting to the host computer interface, and electrically connected to the shared memory controller, the descriptor block and the master interface; and a physical interface, connected to the host computer interface and the host computer connecting physical interface.

2. The system for shared memory for field programmable gate array based application as claimed in claim 1, wherein the field program gate array interface further comprises a slave interface, electrically connected to the host computer connecting physical interface.

3. The system for shared memory for field programmable gate array based application as claimed in claim 1, wherein the physical interface is a Peripheral Component Interconnect Express (PCIe) interface, or a Serial Advanced Technology Attachment (SATA) interface.

4. The system for shared memory for field programmable gate array based application as claimed in claim 1, wherein the host computer interface includes a computer driver for allowing the physical interface to map a design bus function, wherein the design bus function is reading or writing.

5. The system for shared memory for field programmable gate array based application as claimed in claim 1, wherein the field program gate array interface converts a protocol for the physical interface to a protocol for the field program gate array.

6. The system for shared memory for field programmable gate array based application as claimed in claim 1, wherein the host computer connecting physical interface is implemented in the at least one field program gate array, or implemented on the outside of the at least one field program gate array.

7. The system for shared memory for field programmable gate array based application as claimed in claim 1, wherein the shared memory is physically scattered in a plurality of small segments in the host computer memory, and the descriptor block is used for storing an information to map the shared memory to the host computer memory.

8. The system for shared memory for field programmable gate array based application as claimed in claim 7, wherein the information comprises a size, a status, a host physical memory starting address, and a pointer.

9. A method for shared memory for field programmable gate array based application, applied to a system comprising a host computer, a field program gate array and a physical interface, wherein the host computer comprises a shared memory and a host computer memory, the field program gate array includes a descriptor block, the physical interface is connected to the host computer and the field program gate array, the method for shared memory for field programmable gate array based application comprising:
opening an access of the shared memory;
receiving a request for accessing the shared memory;
based on a requested shared memory size, locking the available host computer memory;
writing an allocation information of the host computer memory to the descriptor block of the field program gate array;
after the descriptor block is written, a plurality of processes or applications from the host computer and the field program gate array simultaneously access the shared memory via searching the allocation information of the host computer memory in the descriptor block;
receiving a finishing access information; and
closing the shared memory and free the locking host computer memory.

10. The method for shared memory for field programmable gate array based application as claimed in claim 9, wherein the host computer interface includes a computer driver for allowing the physical interface to map a design bus function, wherein the design bus function is reading or writing.

11. The method for shared memory for field programmable gate array based application as claimed in claim 9, wherein the field program gate array converts a protocol for the physical interface to a protocol for the field program gate array.

12. The method for shared memory for field programmable gate array based application as claimed in claim 9, wherein the shared memory is physically scattered in a plurality of small segments in the host computer memory, and the descriptor block is used for storing an information to map the shared memory to the host computer memory.

13. The method for shared memory for field programmable gate array based application as claimed in claim 12, wherein the information comprises a size, a status, a host physical memory starting address, and a pointer.
